(19) United States
(12) Patent Application Publication
(10) Pub. No.: US 2021/0016281 A1
(43) Pub. Date: Jan. 21, 2021

(54) FLUID DEVICE

(71) Applicants: NIKON CORPORATION, Tokyo (JP); MagArray, Inc., Milpitas, CA (US)

(72) Inventors: Naoya ISHIZAWA, Saitama-shi (JP); Ryo KOBAYASHI, Kawasaki-shi (JP); Taro UENO, Tokyo (JP); Tetsuomi TAKASAKI, Sagamihara-shi (JP); Ronald Adam SEGER, San Jose, CA (US); Matthew Daniel SOLOMON, Victoria (AU); Alexei KOIFMAN, Victoria (AU)

(21) Appl. No.: 16/982,016

(22) PCT Filed: Mar. 19, 2019
(86) PCT No.: PCT/JP2019/012631

§ 371 Date: Sep. 17, 2020

Related U.S. Application Data
(60) Provisional application No. 62/646,492, filed on Mar. 22, 2018.

(51) Int. Cl. B01L 3/00

(52) U.S. Cl. CPC B01L 3/502715; B01L 3/502761; B01L 2400/06; B01L 2200/0689; B01L 2300/088; B01L 2300/0663

(57) ABSTRACT

A fluid device includes a base material including a flow path through which a solution flows and a first facing surface, a treatment substrate including a second facing surface which faces the first facing surface and in which a treatment unit which comes in contact with the solution and treats the solution is provided, and a sealing portion sandwiched between the first facing surface and the second facing surface, in which a treatment space surrounding the treatment unit with the sealing portion when viewed from a plate thickness direction and connected to the flow path is provided between the treatment substrate and the base material.

Priority is claimed on U.S. Provisional Application No. 62/646,492, filed on Mar. 22, 2018, the contents of which are incorporated herein by reference.

### FIELD

The present invention relates to a fluid device.

### BACKGROUND

In recent years, development of micro-total analysis systems (μ-TAS) aimed at high-speed, high efficiency, and integrated testing in the field of in-vitro diagnosis, or micro-miniaturization of inspection equipment, or the like has drawn attention, and active studies are underway worldwide.

μ-TAS is superior to conventional inspection equipment in terms of being able to measure and analyze with a small amount of specimen, being portable, being disposable at low costs, and the like.

Further, when an expensive reagent is used or when multiple analytes with small amounts are inspected, μ-TAS has attracted attention as a method having high usability.

As constituent elements of μ-TAS, a device including a flow path and a pump disposed on the flow path has been reported (Non-Patent Document 1). In such a device, a plurality of solutions are injected into the flow path and the pump is operated to mix the plurality of solutions in the flow path.
[Non-Patent Document 1] Jong Wook Hong, Vincent Studer, Giao Hang, W French Anderson and Stephen R Quake, Nature Biotechnology 22, 435-439 (2004)

### SUMMARY

According to a first aspect, the present invention provides a fluid device including a base material having a flow path through which a solution flows and a first facing surface, a treatment substrate having a second facing surface which faces the first facing surface and in which a treatment unit which comes in contact with the solution and treats the solution is provided, and a sealing portion sandwiched between the first facing surface and the second facing surface, in which a treatment space surrounding the treatment unit with the sealing portion when viewed from a plate thickness direction and connected to the flow path is provided between the treatment substrate and the base material.

### BRIEF DESCRIPTION OF THE DRAWINGS

FIG. 1 is a perspective view of a fluid device of one embodiment.

FIG. 2 is an exploded perspective view of the fluid device of one embodiment.

FIG. 3 is a plan view of the fluid device of one embodiment.

FIG. 4 is a cross-sectional view of the fluid device taken along line IV-IV of FIG. 3.

FIG. 5 is a plan view of a second substrate of one embodiment.

FIG. 6 is a cross-sectional view of the fluid device taken along line VI-VI of FIG. 3.

FIG. 7 is a cross-sectional view of the fluid device taken along line VII-VII of FIG. 3.

FIG. 8 is an enlarged view of a region VIII of FIG. 7.

FIG. 9 is a partial cross-sectional view of a fluid device of a modified example 1.

### DETAILED DESCRIPTION

Hereinafter, an embodiment of a fluid device will be described with reference to the drawings.

### Fluid Device

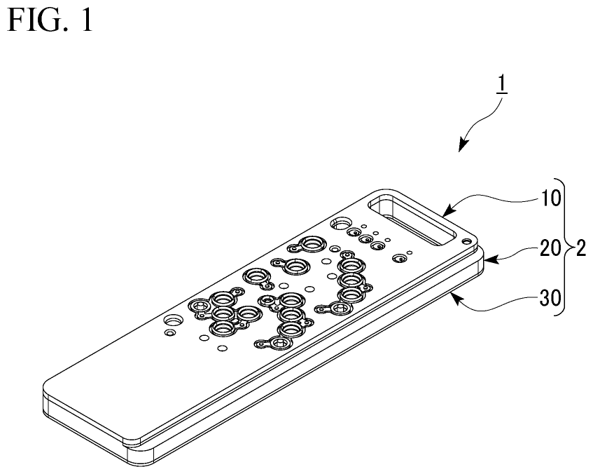

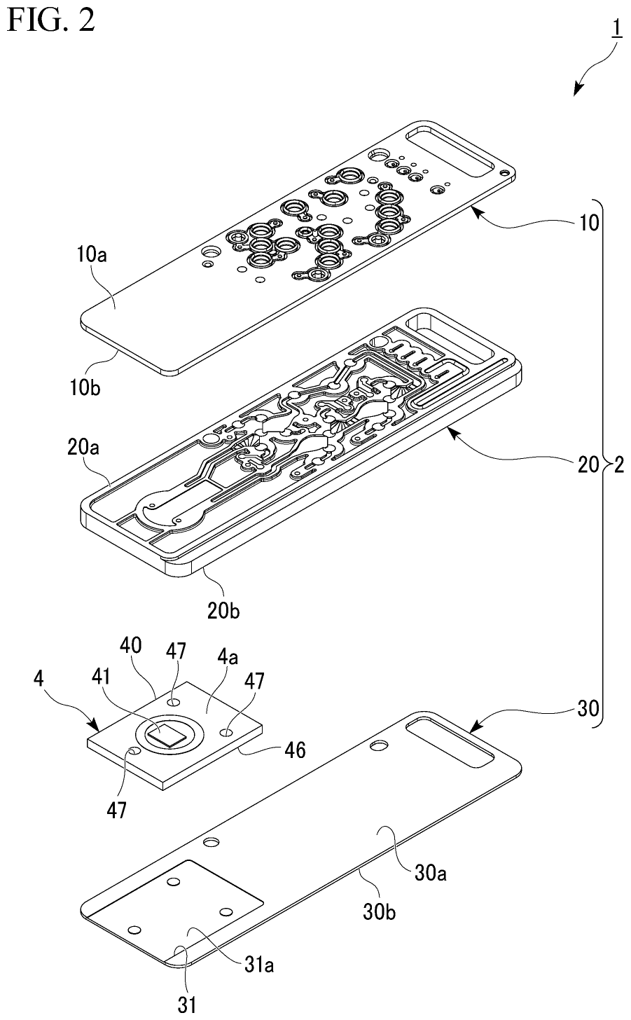

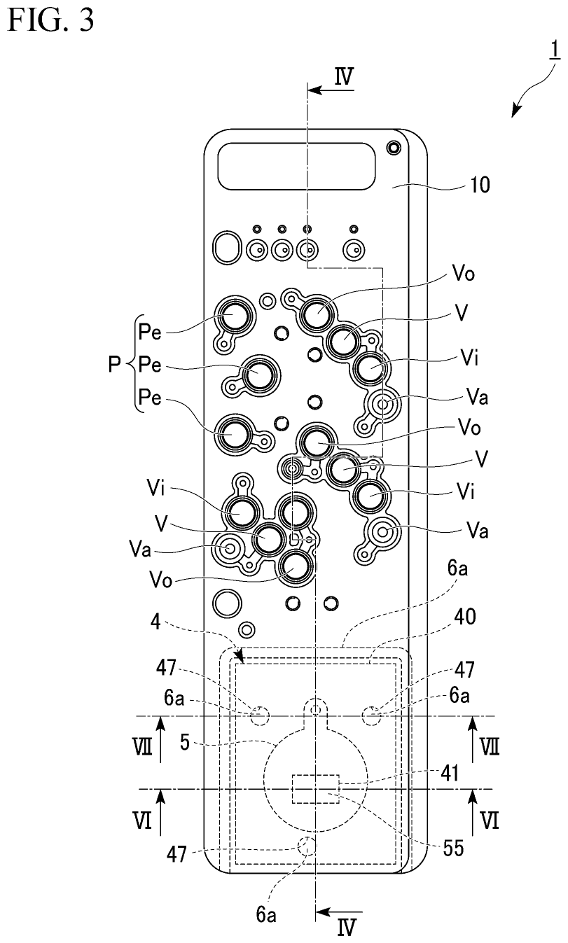

FIG. 1 is a perspective view of a fluid device 1 of the present embodiment. FIG. 2 is an exploded perspective view of the fluid device 1. FIG. 3 is a plan view of the fluid device 1.

The fluid device 1 of the present embodiment includes a device that detects an analytical substance which is a detection target contained in an analytical specimen using an immune reaction, an enzymatic reaction, and the like. The analytical substance is, for example, a biomolecule such as nucleic acid, deoxyribonucleic acid (DNA), ribonucleic acid (RNA), a peptide, a protein, an extracellular vesicle, or the like.

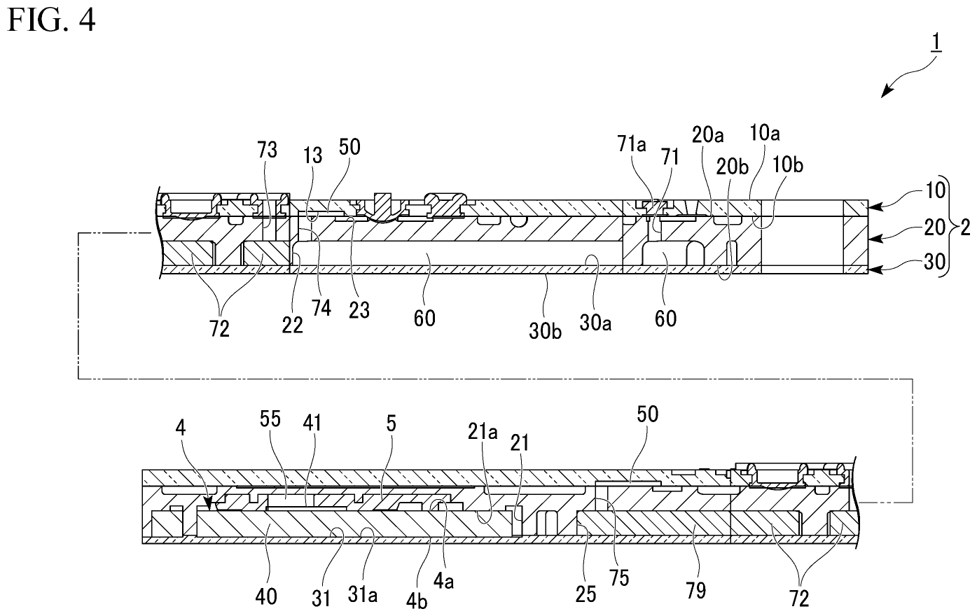

As illustrated in FIG. 2, the fluid device 1 includes a base material 2 and a treatment substrate 4. In addition, as will be described below, a sealing portion 5 is provided in the base material 2 (see FIG. 4). That is, the fluid device 1 includes the sealing portion 5.

The treatment substrate 4 includes a substrate main body 40 and a treatment unit 41.

The substrate main body 40 is a rigid substrate to which biomolecules such as one or a plurality of types of nucleic acids or antibodies bind and provided with a circuit pattern (not illustrated). The substrate main body 40 is formed of, for example, a glass substrate, a quartz glass substrate, a metal plate, a resin substrate, or a glass epoxy.

The treatment unit 41 is provided in the substrate main body 40. The treatment unit 41 comes into contact with a solution flowing through a flow path 50 provided in the base material 2, performs a certain treatment on the solution, reacts with substances in the solution, and detects substances in the solution. The treatment unit 41 is, for example, a detection unit which detects a detection target in the solution. The treatment unit 41 is, for example, a giant magneto resistive sensor (GMR sensor). On a surface of each element of the GMR sensor, for example, an antibody for trapping an antigen which is a detection target may be fixed. In addition, each element of the GMR sensor detects magnetic particles combined with the antigen which is a detection target. That is, in the present embodiment, the GMR sensor as the treatment unit 41 traps and detects an analyte in the solution. Each element of the GMR sensor is connected to the circuit pattern of the substrate main body 40.

A function of the treatment unit 41 is not limited as long as the treatment unit 41 comes in contact with a solution flowing through the flow path 50 provided in the base material 2 and performs a certain treatment on the solution. Further, the treatment unit 41 may be, for example, a reaction unit in which a solution is reacted. As treatments to be applied to a solution by the treatment unit 41, a trapping treatment, a detection treatment, a heat treatment, an antigen-antibody reaction, cross-linkage of nucleic acids, interaction of biomolecules, and the like, can be exemplified. As the treatment unit 41, a DNA array chip, an electric field sensor, a heater, a device for performing chromatography, and the like, can be exemplified.

The base material 2 includes a first substrate (substrate, top plate) 10, a second substrate (substrate, middle plate) 20, and a third substrate (substrate, bottom plate) 30. That is, the base material 2 includes three substrates. The first substrate 10, the second substrate 20, and the third substrate 30 are stacked in a thickness direction of the substrates. The first substrate 10 and the second substrate 20 are welded to each other by welding methods such as laser welding or ultrasonic welding. Similarly, the second substrate 20 and the third substrate 30 are welded to each other by welding methods such as laser welding or ultrasonic welding.

The first substrate 10, the second substrate 20, and the third substrate 30 are formed of a resin material. In a case in which the first substrate 10 and the second substrate 20 are welded and joined and in which the second substrate 20 and the third substrate 30 are welded and joined by laser welding, one of the two substrates to be joined is a light-transmitting resin material that transmits light and the other is a resin material that absorbs light. For example, the first substrate 10 and the third substrate 30 may be formed of a light-transmitting resin material that transmits light. On the other hand, the second substrate 20 may be formed of a colored resin material that absorbs light having a wavelength of a laser or a resin material coated with a coating material that absorbs light having a wavelength of a laser. It is preferable to use a thermoplastic resin material for the first substrate 10, the second substrate 20, and the third substrate 30. However, even if it is a thermoplastic resin material, a carbon fiber reinforced resin is not suitable for the first substrate 10, the second substrate 20, and the third substrate 30. In addition, even if it is a thermoplastic resin material, a resin material having extremely high heat resistance such as a fluorine resin is not suitable for the first substrate 10, the second substrate 20, and the third substrate 30. As resin materials which can be used for the first substrate 10, the second substrate 20 and the third substrate 30, general-purpose resins which are crystalline resins (polypropylene; PP, polyvinyl chloride; PVC, and the like), engineering plastics (polyethylene terephthalate; PET, and the like), super engineering plastics (polyphenylene sulfide; PPS, polyether ether ketone; PEEK, and the like), as well as general-purpose resins which are non-crystalline resin (acrylonitrile butadiene styrene copolymer synthetic resin; ABS, polymethyl methacrylate resin; PMMA, and the like), engineering plastics (polycarbonate; PC, polyphenylene ether; PPE, and the like), and super engineering plastics (polyether sulfone; PES and the like) are examples.

The first substrate 10, the second substrate 20, and the third substrate 30 are stacked in that order. That is, the second substrate 20 is disposed between the first substrate 10 and the third substrate 30. Further, the treatment substrate 4 is disposed between the second substrate 20 and the third substrate 30. Therefore, a portion of the treatment substrate 4 is accommodated inside the base material 2.

The treatment substrate 4, the first substrate 10, the second substrate 20, and the third substrate 30 are plate-like materials extending in parallel along one plane. In the following description, an arrangement of the treatment substrate 4, the first substrate 10, the second substrate 20, and the third substrate 30 will be described as being arranged along a horizontal plane for convenience of description. Further, in the following description, it is assumed that the first substrate 10, the second substrate 20, the treatment substrate 4, and the third substrate 30 are stacked in order from an upper side, and a vertical direction is defined as such. That is, the vertical direction in this specification is a stacking direction and a thickness direction of the first substrate 10, the second substrate 20, the treatment substrate 4, and the third substrate 30.

However, this definition of the horizontal direction and the vertical direction is merely for convenience of description, and does not limit an orientation of the fluid device 1 according to the present embodiment at the time of use.

FIG. 4 is a cross-sectional view of the fluid device 1 taken along line Iv-Iv of FIG. 3.

The treatment substrate 4, the first substrate 10, the second substrate 20, and the third substrate 30 each have an upper surface that faces upward (one side in the stacking direction) and a lower surface that faces downward (the other side in the stacking direction). More specifically, the first substrate 10 includes an upper surface 10a and a lower surface 10b. The second substrate 20 includes an upper surface 20a and a lower surface (first facing surface) 20b. The third substrate 30 includes an upper surface (third facing surface) 30a and a lower surface 30b. That is, the base material 2 includes upper surfaces 10a, 20a, and 30a and lower surfaces 10b, 20b, and 30b. Further, the treatment substrate 4 includes an upper surface (second facing surface) 4a and a lower surface 4b.

The lower surface 10b of the first substrate 10 and the upper surface 20a of the second substrate 20 face each other in the vertical direction. The lower surface 20b of the second substrate 20 and the upper surface 30a of the third substrate 30 face each other in the vertical direction. A portion of an upper surface 4a of the treatment substrate 4 and a portion of the lower surface 20b of the second substrate 20 face each other in the vertical direction. A portion of the lower surface 4b of the treatment substrate 4 and a portion of the upper surface 30a of the third substrate 30 face each other in the vertical direction.

A first accommodating recess (accommodating recess) 21 is provided on the lower surface 20b of the second substrate 20. Similarly, a second accommodating recess (accommodating recess) 31 is provided on the upper surface 30a of the third substrate 30. The first accommodating recess 21 and the second accommodating recess 31 overlap each other when viewed from the vertical direction. The first accommodating recess 21 and the second accommodating recess 31 accommodate the treatment substrate 4. A bottom surface 21a of the first accommodating recess 21 is in contact with the upper surface 4a of the treatment substrate 4. A bottom surface 31a of the second accommodating recess 31 is in contact with the lower surface 4b of the treatment substrate 4. A portion of a region of the lower surface 20b of the second substrate 20 excluding the first accommodating recess 21 and a portion of a region of the upper surface 30a of the third substrate 30 excluding the second accommodating recess 31 are in contact with each other. Thereby, in the base material 2, the treatment substrate 4 is sandwiched between the lower surface 20b of the second substrate 20 and the upper surface 30a of the third substrate 30. That is, the base material 2 includes a pair of substrates (the second substrate 20 and the third substrate 30) sandwiching the treatment substrate 4.

A reservoir 60 which stores a solution, the flow path 50 through which the solution flows, an injection hole 71, a supply hole 74, a waste fluid tank 72, a discharge hole 75, and an air hole 73 are provided in the base material 2.

The reservoir 60 is provided between the second substrate 20 and the third substrate 30. The reservoir 60 is a space surrounded by an inner wall surface of a groove portion 22 provided on the lower surface 20b of the second substrate 20 and the upper surface 30a of the third substrate 30. The reservoir 60 is, for example, a space formed in a tubular shape or a cylindrical shape. A plurality of reservoirs 60 are provided in the base material 2 of the present embodiment. Solutions are accommodated in the reservoirs 60. The plurality of reservoirs 60 accommodate the solutions independently of each other. The reservoirs 60 of the present embodiment are reservoirs of a flow path type. One end of each of the reservoirs 60 in a longitudinal direction is connected to the injection hole 71. The other end of the reservoir 60 in the longitudinal direction is connected to the supply hole 74. In a process of manufacturing the fluid device 1, a solution is injected into the reservoir 60 from the injection hole 71. At the time of using the fluid device 1, the reservoir 60 supplies the accommodated solution to the flow path 50 via the supply hole 74.

The flow path 50 is provided between the first substrate 10 and the second substrate 20. The flow path 50 is constituted by, for example, a groove portion formed on a joining surface between the first substrate 10 and the second substrate 20. The flow path 50 may be constituted by a space surrounded by a groove portion provided on the lower surface 10b of the first substrate 10 and the upper surface 20a of the second substrate 20, by a space surrounded by the lower surface 10b of the first substrate 10 and a groove portion provided on the upper surface 20a of the second substrate 20, or by a space surrounded by a groove portion provided on the lower surface 10b of the first substrate 10 and a groove portion provided on the upper surface 20a of the second substrate 20. In the present embodiment, a portion of the flow path 50 is configured as a space surrounded by a groove portion 13 provided on the lower surface 10b of the first substrate 10 and the upper surface 20a of the second substrate 20. In addition, a portion of the flow path 50 is configured as a space surrounded by the lower surface 10b of the first substrate 10 and a groove portion 23 provided on the upper surface 20a of the second substrate 20. Further, a portion of the flow path 50 is configured as a space surrounded by the groove portion 13 provided on the lower surface 10b of the first substrate 10 and the groove portion 23 provided on the upper surface 20a of the second substrate 20. The flow path 50 is a space formed in a tubular shape or a cylindrical shape. The flow path 50 is supplied with a solution from the reservoir 60. The solution flows through the flow path 50.

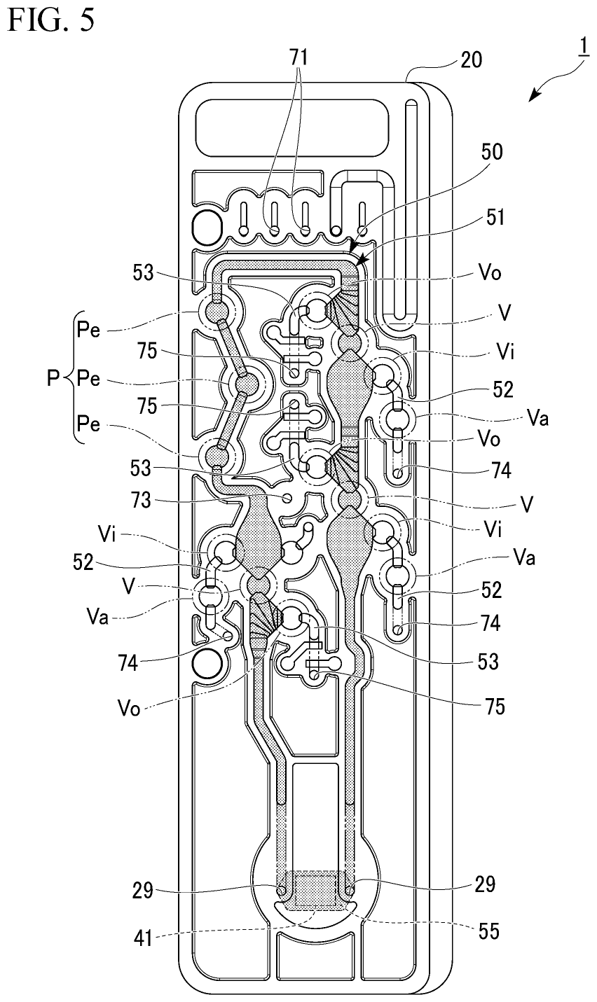

Regarding each portion of the flow path 50, it will be described below in detail on the basis of FIG. 5.

The injection hole 71 penetrates the first substrate 10 and the second substrate 20 in a plate thickness direction. The injection hole 71 is connected to the reservoir 60 positioned at a boundary portion between the second substrate 20 and the third substrate 30. The injection hole 71 connects the reservoir 60 to the outside. One injection hole 71 is provided for one reservoir 60.

A septum 71a is provided in an opening of the injection hole 71. An operator (or an injection device) performs an operation of injecting a solution into the reservoir 60 using, for example, a syringe filled with the solution. The operator pierces a hollow needle attached to the syringe into the septum 71a to inject the solution into the reservoir 60.

Further, the septum 71a may not be provided in the opening of the injection hole 71. In this case, a seal affixed after injection of the solution into the reservoir 60 is provided in the opening of the injection hole 71.

The supply hole 74 is provided in the second substrate 20. The supply hole 74 penetrates the second substrate 20 in the plate thickness direction. The supply hole 74 connects the reservoir 60 to the flow path 50. The solution stored in the reservoir 60 is supplied to the flow path 50 via the supply hole 74.

The waste fluid tank 72 is provided in the base material 2 for discarding the solution in the flow path 50. The waste fluid tank 72 is connected to the flow path 50 via the discharge hole 75. The waste fluid tank 72 is constituted by a space surrounded by a waste fluid recess 25 provided on the lower surface 20b of the second substrate 20 and the upper surface 30a of the third substrate 30. The waste fluid tank 72 is filled with an absorbent material 79 that absorbs a waste fluid.

The discharge hole 75 penetrates the second substrate 20 in the plate thickness direction. The discharge hole 75 connects the flow path 50 to the waste fluid tank 72. The solution in the flow path 50 is discharged to the waste fluid tank 72 via the discharge hole 75.

The air hole 73 penetrates the first substrate 10 and the second substrate 20 in the plate thickness direction. The air hole 73 is positioned immediately above the waste fluid tank 72. The air hole 73 connects the waste fluid tank 72 to the outside. That is, the waste fluid tank 72 is open to the outside via the air hole 73.

Next, the flow path 50 will be more specifically described.

FIG. 5 is a plan view of the second substrate 20.

In FIG. 5, portions of the flow path 50 are complemented and displayed by a double dotted-dashed line or a broken line. Further, in FIG. 5, a circulation flow path 51 which is a portion of the flow path 50 is emphasized and displayed by a dot pattern.

The flow path 50 includes the circulation flow path 51, a plurality of introduction flow paths 52, and a plurality of discharge flow paths 53.

The circulation flow path 51 is formed in a loop shape when viewed from the stacking direction. In a path of the circulation flow path 51, a pump P is disposed. The pump P is constituted by three element pumps Pe disposed side by side in the flow path. The element pumps Pe are so-called valve pumps. The pump P sequentially opens and closes the three element pumps Pe to convey a liquid in the circulation flow path 51. The number of the element pumps Pe constituting the pump P may be three or more, and may be four or more.

In the path of the circulation flow path 51, a plurality of (three in the present embodiment) quantitative valves V are provided. The plurality of quantitative valves V partition the circulation flow path 51 into a plurality of quantitative sections. By closing the plurality of quantitative valves V, the plurality of sections are defined in the circulation flow path 51. The plurality of quantitative valves V are disposed such that each of the quantitative sections has a predetermined volume. An introduction flow path 52 is connected to one end of each of the quantitative sections. Further, a discharge flow path 53 is connected to the other end of the quantitative sections.

The introduction flow path 52 is a flow path for introducing a solution into the quantitative section of the circulation flow path 51. At least one introduction flow path 52 is provided for one quantitative section. The introduction flow path 52 is connected to the supply hole 74 on one end side. Further, the introduction flow path 52 is connected to the circulation flow path 51 on the other end side. An introduction valve Vi and an initial close valve Va are provided in the path of the introduction flow path 52.

The initial close valve Va is a valve that is closed only in an initial state at the time of shipping the fluid device 1. By providing the initial close valve Va, it is possible to prevent the solution in the reservoir 60 from flowing into the flow path 50 during transportation from shipping until being used.

The introduction valve Vi is opened at the time of introducing the solution from the reservoir 60 into the flow path 50, and is closed in other states.

The discharge flow path 53 is a flow path for discharging the solution in the circulation flow path 51 to the waste fluid tank 72. The discharge flow path 53 is connected to the waste fluid tank 72 on one end side. Further, the discharge flow path 53 is connected to the circulation flow path 51 on the other end side. A discharge valve Vo is provided in a path of the discharge flow path 53.

The discharge valve Vo is opened when discharging the solution from the flow path 50 to the waste fluid tank 72, and is closed in other states.

The circulation flow path 51 includes a treatment space 55. The solution in the circulation flow path 51 passes through the treatment space 55 during circulation. The treatment unit 41 of the treatment substrate 4 is disposed in the treatment space 55. That is, the treatment unit 41 is positioned inside the treatment space 55. The treatment unit 41 is provided on the upper surface 4a of the treatment substrate 4. The treatment unit 41 comes in contact with the solution in the treatment space 55 to treat the solution.

A treatment of the solution by the fluid device 1 will be described.

In the fluid device 1, solutions in the plurality of reservoirs 60 are respectively introduced into different quantitative sections of the circulation flow path 51 to perform quantification of the solutions. Next, the fluid device 1 opens the quantitative valve V and actuates the pump P. Thereby, the solutions quantified in the respective quantitative sections are circulated and mixed in the circulation flow path 51. Also, an analyte (for example, an antigen) in the solution is trapped in the treatment unit 41. Next, the solution in the circulation flow path 51 is discharged to the waste fluid tank 72. Next, the solution containing magnetic particles is supplied into the circulation flow path 51 and circulated. Thereby, magnetic particles are combined with the antigen trapped by the treatment unit 41. Further, the treatment unit 41 detects the magnetic particles.

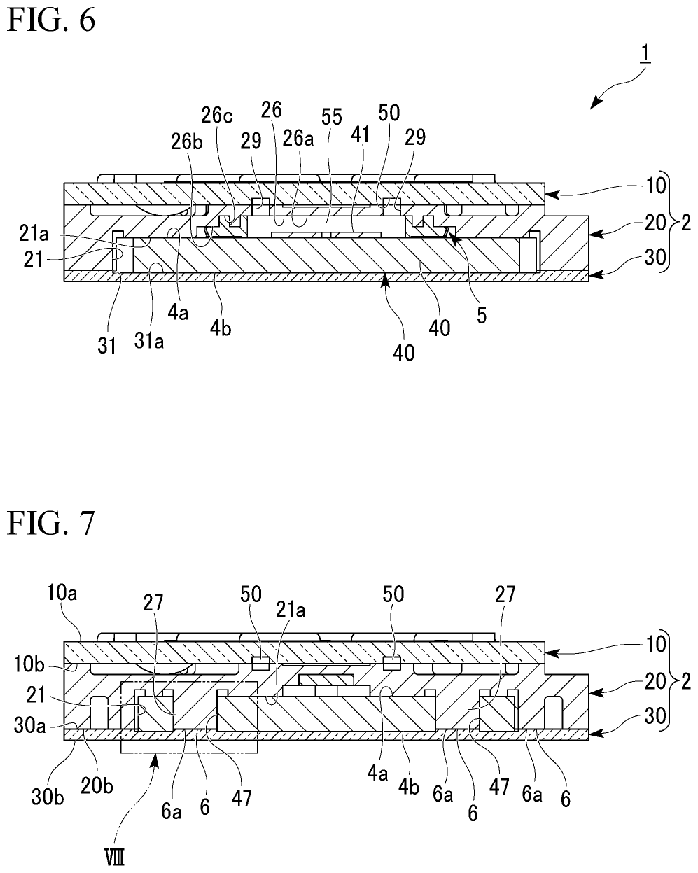

FIG. 6 is a cross-sectional view of the fluid device 1 taken along line VI-VI of FIG. 3.

The first accommodating recess 21 for accommodating the treatment substrate 4 is provided on the lower surface 20b of the second substrate 20. The first accommodating recess 21 is a recess in which the lower surface 20b side of the second substrate 20 is open. The first accommodating recess 21 includes a treatment recess 26. A portion which is a surface of the first accommodating recess 21 on a side opposite to the opening surface and not connected to the treatment recess 26 is referred to as the bottom surface 21a of the first accommodating recess 21. The bottom surface 21a of the first accommodating recess 21 is in contact with the upper surface 4a of the treatment substrate 4. The treatment recess (recess) 26 is provided on the bottom surface 21a of the first accommodating recess 21. An area of the bottom surface of the treatment recess 26 is smaller than an area of a bottom surface of the first accommodating recess 21 when viewed from the vertical direction. That is, the treatment recess 26 is provided in a portion of the bottom surface 21a of the first accommodating recess 21. The treatment space 55 is formed inside the treatment recess 26. The bottom surface 26a of the treatment recess 26 faces the treatment unit 41 of the treatment substrate 4 in the vertical direction. The treatment space 55 is provided between the bottom surface of the treatment recess 26 and the upper surface 4a of the treatment substrate 4 in the vertical direction. That is, the treatment space 55 is provided between the second substrate 20 and the treatment substrate 4 in the vertical direction.

A pair of insertion holes 29 are provided in the bottom surface 26a of the treatment recess 26. The insertion holes 29 are through holes penetrating the second substrate 20 in the plate thickness direction. That is, a pair of insertion holes 29 are provided in the second substrate 20. The insertion holes 29 are open to the flow path 50 on the upper surface 20a side of the second substrate 20 and are open to the treatment space 55 on the lower surface 20b side of the second substrate 20. That is, the pair of insertion holes 29 connect the flow path 50 between the first substrate 10 and the second substrate 20 to the treatment space 55. The solution flows into the treatment space 55 via one of the insertion holes 29 out of the pair of insertion holes 29 and flows out from the treatment space 55 to the flow path 50 via the other insertion hole 29. The treatment unit 41 is disposed between the pair of insertion holes 29 when viewed from the vertical direction. Therefore, the solution comes into contact with a surface of the treatment unit 41 as it passes through the treatment space 55.

As illustrated in FIG. 3, the treatment space 55 is surrounded by the sealing portion 5 when viewed from the vertical direction. The treatment space 55 is surrounded by the bottom surface 26a of the treatment recess 26 in the second substrate 20, the sealing portion 5, and the upper surface 4a of the treatment substrate 4. The sealing portion 5 has an annular shape when viewed from the vertical direction. As illustrated in FIG. 6, a surface facing an upper side of the sealing portion 5 is in contact with the lower surface 20b of the second substrate 20 (more specifically, a stepped surface 26b). The surface facing the upper side of the sealing portion 5 is in contact with the upper surface 4a of the treatment substrate 4. In addition, the sealing portion 5 surrounds the treatment space 55 when viewed from the vertical direction.

In this specification, the “annular shape when viewed from the vertical direction” is not limited to a case of circular shape when viewed from the vertical direction. That is, the sealing portion 5 may have any shape as long as it surrounds a predetermined region (the treatment space 55 and the treatment unit 41 in the treatment space 55 in the present embodiment) when viewed from the vertical direction.

The sealing portion 5 is formed of, for example, an elastic material. Rubber, elastomer resins, and the like are examples of the elastic material that can be employed for the sealing portion 5. The sealing portion 5 and the second substrate 20 may be formed of different materials and integrally with each other. For example, the sealing portion 5 and the second substrate 20 may be a body integrally molded by two-color molding as a double mode molding, injection molding, insert molding, or the like. Further, a plurality of valves V, Va, Vi, Vo, and a septum 71a may be integrally provided in the second substrate 20 in addition to the sealing portion 5. The sealing portion 5, the plurality of valves V, Va, Vi, and Vo, and the septum 71a may be formed of the same materials. In this case, the second substrate 20, the plurality of valves V, Va, Vi, and Vo, and the septum 71a can be integrally molded by two-color molding (a double mode molding) using two kinds of resin material. The sealing portion 5 may be a separate member independent of the second substrate 20 as long as the sealing portion 5 can seal the fluid in contact with the surface of the treatment unit 41 in the treatment space 55.

The stepped surface 26b is provided on an inner peripheral surface of the treatment recess 26. The stepped surface 26b faces the upper surface 4a of the treatment substrate 4. The sealing portion 5 is sandwiched between the stepped surface 26b and the upper surface 4a of the treatment substrate 4. That is, the sealing portion 5 is sandwiched between the lower surface 20b of the second substrate 20 and the upper surface 4a of the treatment substrate 4.

A recessed groove 26c is provided on the stepped surface 26b of the treatment recess 26. The recessed groove 26c is provided in an annular shape when viewed from the vertical direction. The recessed groove 26c is filled with an elastic material constituting the sealing portion 5. By providing the recessed groove 26c on the stepped surface 26b, a contact area between the stepped surface 26b and the sealing portion 5 increases. Thereby, it is possible to increase the peeling strength of the sealing portion 5 with respect to the second substrate 20 when the sealing portion 5 is formed on the second substrate 20 by two-color molding.

In the present embodiment, the fluid device 1 includes a base material 2 in which a flow path 50 is provided and a treatment substrate 4 on which a treatment unit 41 for treating a solution is mounted. Further, the treatment unit 41 is disposed in the treatment space 55 connected to the flow path 50. Therefore, it is desirable to seal the treatment space 55 to inhibit leakage of the solution. Since the treatment substrate 4 and the base material 2 are made of different materials, it is difficult to seal the treatment space 55 by a method such as welding.

According to the fluid device of the present embodiment, the sealing portion 5 is sandwiched between the base material 2 and the treatment substrate 4. In addition, a treatment space 55 is provided inside the sealing portion 5 when viewed from the vertical direction. Therefore, by sealing the treatment space 55, it is possible to prevent the solution in the treatment space 55 from flowing out to the outside.

According to the present embodiment, the treatment space 55 is configured as an internal space of the treatment recess 26 provided in the second substrate 20. The bottom surface 26a of the treatment recess 26 faces the treatment unit 41 in the vertical direction. On the other hand, it is also conceivable that a large through-hole enclosing the treatment unit be provided on the second substrate so that a space between the upper surface of the treatment substrate and the lower surface of the first substrate is used as a treatment space. However, by providing the treatment recess 26, it is possible to reduce a width of the flow path of the treatment space 55 in the vertical direction and increase a frequency with which the analyte molecules in the solution passing through the treatment space 55 collide with the treatment unit 41. Thereby, treatment efficiency of the treatment unit 41 can be enhanced.

According to the present embodiment, the stepped surface 26b is provided on the inner peripheral surface of the treatment recess 26, and the sealing portion 5 is sandwiched between the stepped surface 26b and the upper surface 4a of the treatment substrate 4. Therefore, a compression ratio of the sealing portion 5 can be easily set according to a depth of the stepped surface 26b, and the reliability of sealing of the treatment space 55 by the sealing portion 5 can be enhanced.

In the present embodiment, the sealing portion 5 is integrally molded with the second substrate 20, but the sealing portion 5 and the second substrate 20 may be separate members. When the sealing portion 5 is a member separate from the second substrate 20, by disposing the sealing portion 5 on the stepped surface 26b, a positional displacement of the sealing portion 5 with respect to the second substrate 20 can be inhibited.

According to the present embodiment, the flow path 50 provided between the first substrate 10 and the second substrate 20 is connected to the treatment space 55 by the pair of insertion holes 29 provided in the second substrate 20. Therefore, it is possible to supply the solution from the flow path 50 to the treatment space 55 while securing sealing by the sealing portion 5.

In the present embodiment, the insertion holes 29 extend parallel to the plate thickness direction of the second substrate 20. Further, in the present embodiment, the insertion holes 29 have a circular shape having a uniform cross-sectional area along the plate thickness direction. However, a shape of the insertion holes 29 is not limited to that in the present embodiment. For example, the insertion holes 29 may extend obliquely with respect to the plate thickness direction of the second substrate 20. In this case, it is possible to smoothly introduce the solution from the flow path 50 to the treatment space 55 via the insertion holes 29.

According to the present embodiment, accommodating recesses (the first accommodating recess 21 and the second accommodating recess 31) each accommodating a portion of the treatment substrate 4 in the vertical direction are provided in the second substrate 20 and the third substrate 30. Thereby, the lower surface 20b of the second substrate 20 and the upper surface 30a of the third substrate 30 are in contact with each other. Therefore, by fixing the second substrate 20 and the third substrate 30 to each other on a contact surface thereof by a fixing method such as welding, or the like, the treatment substrate 4 can be easily fixed to the base material 2. In addition, when the second substrate 20 and the third substrate 30 are brought into contact with each other and fixed with the treatment substrate 4 being sandwiched between the second substrate 20 and the third substrate 30, the sealing portion 5 sandwiched between the second substrate 20 and the treatment substrate 4 can be constantly compressed. As a result, reliability of the sealing the treatment space 55 can be enhanced. Further, any one of the first accommodating recess 21 and the second accommodating recess 31 may be provided in the base material 2.

FIG. 7 is a cross-sectional view of the fluid device 1 taken along line VII-VII of FIG. 3.

The lower surface 20b of the second substrate 20 and the upper surface 30a of the third substrate 30 are in contact with each other around the treatment substrate 4. On the lower surface 20b of the second substrate 20 and the upper surface 30a of the third substrate 30, a region in contact with the other thereof is called a contact surface 6. That is, the pair of substrates (the second substrate 20 and the third substrate 30) sandwiching the treatment substrate 4 from the vertical direction have the contact surface 6 facing and in contact with the other substrate in the plate thickness direction.

A welded portion 6a in which the pair of substrates (the second substrate 20 and the third substrate 30) are welded is provided at least on a portion of the contact surface 6.

The welded portion 6a is where the second substrate 20 and the third substrate 30 are joined to each other. At the welded portion 6a, a portion of the contact surface 6 of the second substrate 20 and the third substrate 30 is melted and re-solidified so that the second substrate 20 and the third substrate are joined to each other. As welding methods, laser welding, ultrasonic welding, thermal welding, and the like are examples.

A plurality (three in the present embodiment) of through holes 47 penetrating in the plate thickness direction are provided in the treatment substrate 4. In addition, as illustrated in FIG. 2, in the present embodiment, the through holes 47 are circular when viewed from the vertical direction. A diameter of each of the through holes 47 is uniform over the entire length of the through hole 47. The three through holes 47 are disposed surrounding the treatment unit 41 around the treatment unit 41 when viewed from the vertical direction. The through holes 47 are provided in a portion of the treatment substrate 4 other than the treatment unit 41.

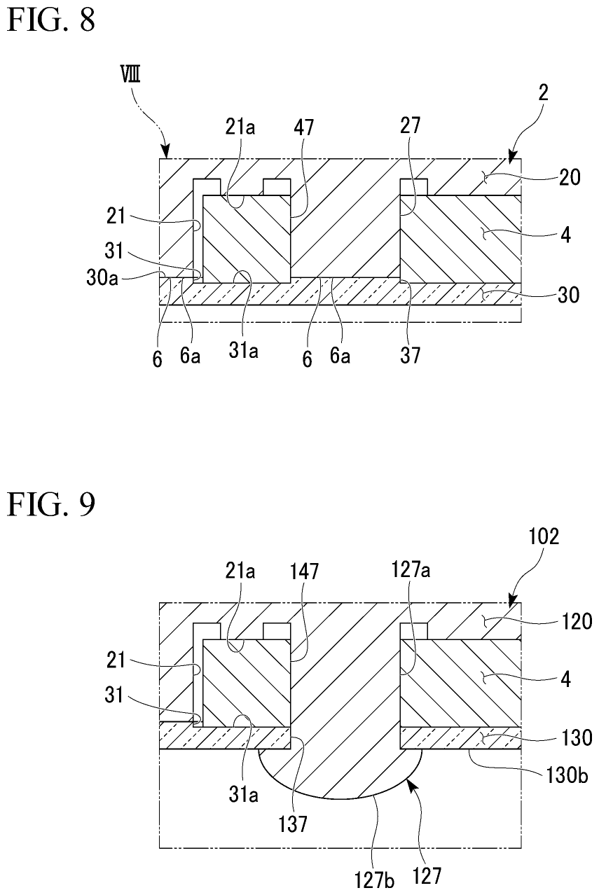

FIG. 8 is an enlarged view of a region VIII of FIG. 7.

As illustrated in FIG. 8, a first convex portion (convex portion, protruding portion) 27 protruding toward the third substrate 30 side is provided in the second substrate 20. The first convex portion 27 extends downward from the bottom surface 21a of the first accommodating recess 21 of the second substrate 20. The first convex portion 27 is circular when viewed from the vertical direction. The first convex portion 27 is inserted into the through hole 47 of the treatment substrate 4. The first convex portion 27 is fitted into the through hole 47. The first convex portion 27 has a columnar shape and is a support member inserted into the through hole 47 of the treatment substrate. The same number of first convex portions 27 is provided on the second substrate 20 as that of the through holes 47 provided in the treatment substrate 4. That is, three first convex portions 27 are provided on the second substrate 20 of the present embodiment.

A second convex portion (convex portion, protruding portion) 37 protruding toward the second substrate 20 side is provided in the third substrate 30. The second convex portion 37 extends upward from the bottom surface 31a of the second accommodating recess 31 of the third substrate 30. The second convex portion 37 is circular when viewed from the vertical direction. The second convex portion 37 is inserted into the through hole 47 of the treatment substrate 4. The second convex portion 37 is fitted into the through hole 47. The second convex portion 37 has a columnar shape and is a support member inserted into the through hole 47 of the treatment substrate. The same number of second convex portions 37 is provided on the third substrate 30 as that of the through holes 47 provided in the treatment substrate 4. That is, three second convex portions 37 are provided on the third substrate 30 of the present embodiment.

The first convex portion 27 and the second convex portion 37 overlap each other when viewed from the vertical direction. The first convex portion 27 and the second convex portion 37 are inserted into the through hole 47 of the treatment substrate 4 respectively from the side above and the side below. A distal end (lower end) of the first convex portion 27 and a distal end (upper end) of the second convex portion 37 are in contact with each other in the through hole 47. That is, at the distal end of the first convex portion 27 and at the distal end of the second convex portion 37, the contact surface 6 on which the pair of substrates (the second substrate 20 and the third substrate 30) are in contact with each other is provided. In addition, the welded portion 6a is positioned on the contact surface 6 of the distal end of the first convex portion 27 and the distal end of the second convex portion 37. Therefore, the second substrate 20 and the third substrate 30 are joined to each other also inside the through hole 47 of the treatment substrate 4.

In the present embodiment, the fluid device 1 includes the base material 2 in which the flow path 50 is provided and the treatment substrate 4 on which the treatment unit 41 for treating a solution is mounted. Further, as described above, the treatment substrate 4 is fixed to the base material 2 by welding the second substrate 20 and the third substrate 30. Generally, glass epoxy or the like excellent in insulating properties is generally used as the treatment substrate having mounted components. On the other hand, a resin material having excellent processability is employed as the base material so that a flow path through which a solution flows is provided. In other words, the treatment substrate 4 and the base material 2 are generally materials different from each other. Further, in fluid devices, in general, welding is suitably employed for fixing substrates to each other for the purpose of reducing a size and the like. There is a problem in that sufficient reliability cannot be easily obtained when the treatment substrate 4 and the base material 2 which are different materials are directly fixed by welding.

According to the fluid device 1 of the present embodiment, the base material 2 includes the second substrate 20 and the third substrate 30 which sandwich the treatment substrate 4 in the plate thickness direction. In addition, the second substrate 20 and the third substrate 30 have mutual contact surfaces 6, and the welded portion 6a is provided on the contact surface 6. At the welded portion 6a, the second substrate 20 and the third substrate 30 are welded to each other. Therefore, even though materials of the treatment substrate 4 and the base material 2 are different from each other, the treatment substrate 4 can be fixed to the base material 2. Thereby, reliability of fixing the treatment substrate 4 to the base material 2 can be enhanced. It is preferable that the second substrate 20 and the third substrate 30 be materials having satisfactory joining properties. In addition, when the second substrate 20 and the third substrate 30 are the same materials, there is less susceptibility to an influence due to a difference in linear expansion coefficient as compared with a case in which different materials are joined.

Further, in the second substrate 20 and the third substrate 30 of the present embodiment, convex portions (the first convex portion 27 and the second convex portion 37) inserted into the through hole 47, provided in the treatment substrate 4, from opposite sides and in contact with each other therein are respectively provided. Further, on the distal ends of the first convex portion 27 and the second convex portion 37, the contact surface 6 at which the distal ends are in contact with each other is provided. The welded portion 6a is positioned on the contact surface 6 of the distal ends of the first convex portion 27 and the second convex portion 37.

Therefore, according to the present embodiment, the welded portion 6a can be disposed on an inner side of an outer edge of the treatment substrate 4 when viewed from the vertical direction. Since the welded portion 6a is positioned on the inner side of the outer edge of the treatment substrate 4, peeling of the welded portion 6a can be effectively inhibited even when stress is applied to the treatment substrate 4 with respect to the base material 2. As a result, reliability of fixing the treatment substrate 4 to the base material 2 can be further enhanced.

According to the present embodiment, since the welded portion 6a is positioned on the inner side of the outer edge of the treatment substrate 4, the welded portion 6a can be disposed close to the sealing portion 5 sandwiched between the second substrate 20 and the treatment substrate 4. When the sealing portion 5 and the welded portion 6a are disposed away from each other, the second substrate 20 and the treatment substrate 4 may be bent due to a reaction force of the sealing portion 5 and compression of the sealing portion 5 may be insufficient. According to the present embodiment, since the welded portion 6a is positioned on the inner side of the outer edge of the treatment substrate 4, an influence of the bending of the second substrate 20 and the treatment substrate 4 is reduced, and reliability of sealing the treatment space 55 by the sealing portion 5 can be enhanced.

Further, in the present embodiment, the case in which convex portions (the first convex portion 27 and the second convex portion 37) inserted into the through hole 47 are respectively provided in the second substrate 20 and the third substrate 30 has been described. However, the convex portion may be provided in any one of the pair of substrates (the second substrate 20 and the third substrate 30). For example, in a case in which the first convex portion 27 is provided in the second substrate 20 and a convex portion is not provided in the third substrate 30, the first convex portion 27 passes through the entire length of the through hole 47, comes into contact with the second substrate at the lower end of the through hole 47, and is welded.

That is, it is sufficient if a convex portion protruding toward the other substrate side and inserted into the through hole 47 is provided at least at one of the pair of substrates (the second substrate 20 and the third substrate 30), a contact surface coming in contact with the other substrate is provided at a distal end of the convex portion, and a welded portion is positioned on the contact surface at the distal end of the convex portion. With such a configuration, the welded portion 6a can be positioned on the inner side of the outer edge of the treatment substrate 4.

According to the present embodiment, since the first convex portion 27 provided on the second substrate 20 is inserted into the through hole 47 of the treatment substrate 4, the second substrate 20 can be aligned with respect to the treatment substrate 4 in a direction perpendicular to the plate thickness. Thereby, the treatment unit 41 can be accurately disposed in a center of the treatment recess 26 of the second substrate 20. In addition, the sealing portion 5 integrally molded with the lower surface 20b of the second substrate 20 is accurately pressed against a predetermined position on the treatment substrate 4, and thereby reliability of sealing of the treatment space 55 can be enhanced.

Similarly, according to the present embodiment, since the second convex portion 37 provided on the third substrate 30 is inserted into the through hole 47 of the treatment substrate 4, the third substrate 30 can be aligned with respect to the treatment substrate 4 in a direction perpendicular to the plate thickness.

As illustrated in FIG. 3, according to the present embodiment, the welded portion 6a is provided around the outer edge of the treatment substrate 4 and inside the through holes 47 positioned on the inner side of the outer edge of the treatment substrate 4 when viewed from the vertical direction. Thereby, the treatment substrate 4 can be more firmly fixed to the base material 2.

As illustrated in FIG. 8, in the third substrate 30 of the present embodiment, a height of the second convex portion 37 protruding from the bottom surface 31a of the second accommodating recess 31 coincides with a depth of the second accommodating recess 31. Therefore, a position in the plate thickness direction of the contact surface 6 positioned at the distal ends of the first convex portion 27 and the second convex portion 37 coincides with a position in the plate thickness direction of the contact surface 6 between the second substrate 20 and the third substrate 30 around the treatment substrate 4. The welded portion 6a of the present embodiment is a laser welded portion formed by melting and re-solidifying a portion of the contact surface 6 with a laser beam. By aligning positions in the plate thickness direction of the welded portions 6a positioned on an outer side of the outer edge of the treatment substrate 4 and inside the through holes 47 with each other, welding conditions such as a spot diameter and an output of a laser beam when each welded portion 6a is formed can be made the same. Therefore, according to the present embodiment, since the welded portions 6a on the outer side of the outer edge of the treatment substrate 4 and inside the through holes 47 can be formed using a single set of welding conditions, productivity of the fluid device 1 can be enhanced.

Further, according to the present embodiment, a plurality of through holes 47 provided in the treatment substrate 4 are disposed to surround a periphery of the sealing portion 5 when viewed from the vertical direction. Therefore, the sealing portion 5 can be uniformly compressed by the welded portion 6a, and reliability of sealing the treatment space 55 by the sealing portion 5 can be enhanced.

In the present embodiment, the pair of substrates (the second substrate 20 and the third substrate 30) welded to each other by the welded portion 6a are the same type of resin materials. Thermal expansion coefficients of the same type of resin materials are close to each other. When the same type of resin materials are used for the second substrate 20 and the third substrate 30, a thermal stress applied to the welded portion 6a can be reduced even when the second substrate 20 and the third substrate 30 thermally expand or thermally contract due to a change in temperature of a surrounding environment or heat generated by the treatment unit 41. Thereby, occurrence of damage to the welded portion 6a is inhibited, and reliability of fixing the treatment substrate 4 to the base material 2 can be enhanced.

As a combination of a resin material constituting the second substrate 20 and a resin material constituting the third substrate 30, it is preferable to employ resin materials having compatibility with each other. By welding resin materials having high compatibility with each other, occurrence of interfacial peeling can be inhibited. Besides being the same type of resin material, a combination of PC and ABS, a combination of PC and PET, and the like are examples of such resin materials having high compatibility.

Further, in the present embodiment, the first substrate 10 and the second substrate 20 are also welded to each other. Therefore, it is preferable that the first substrate 10 and the second substrate 20 be the same type of resin materials that satisfy the above-described relationship.

In the present embodiment, the welded portion 6a is a laser welded portion. That is, the welded portion 6a is formed by irradiating the contact surface 6 with a laser beam, and melting and re-solidifying the second substrate 20 and the third substrate 30 on the contact surface 6. By using laser welding, localized welding is possible. Further, by scanning with the laser beam, it is possible to weld the outer side of the outer edge of the treatment substrate 4 and the inside of the through holes 47 in a single welding step.

When the welded portion 6a is a laser welded portion, one of the pair of substrates (the second substrate 20 and the third substrate 30) welded to each other due to the welded portion 6a is configured to transmit light and the other is configured to absorb light. In the present embodiment, the third substrate 30 is formed of a resin material that transmits light, and the second substrate 20 is formed of a resin material that absorbs light. Thereby, a surface of the second substrate 20 that absorbs light can be heated by laser light irradiated from a side of the third substrate 30 that transmits light. Further, in the present embodiment, the first substrate 10 and the second substrate 20 also are laser welded to each other. Therefore, the first substrate 10 is formed of a resin material that transmits light.

### Modified Example 1

A fixing method of the treatment substrate 4 that can be employed in the above embodiment will be described on the basis of FIG. 9 as a first modified example. FIG. 9 is a view corresponding to FIG. 8 in the description of the above embodiment.

Constituent elements the same as in the embodiment described above are given the same reference signs, and description thereof will be omitted.

As in the embodiment described above, a base material 102 of the present modified example includes a second substrate 120 and a third substrate 130 that sandwich the treatment substrate 4 from the vertical direction. Further, a first through hole 147 is provided in the treatment substrate 4.

In the present modified example, a second through hole 137 overlapping a first through hole 147 of the treatment substrate 4 is provided in the third substrate 130. The first through hole 147 and the second through hole 137 are circular when viewed from the vertical direction. Also, diameters of the first through hole 147 and the second through hole 137 are substantially equal.

A convex portion 127 protruding toward the third substrate 130 side is provided on the second substrate 120. The convex portion 127 includes a columnar portion 127a and a thermally caulked portion 127b positioned at a distal end of the columnar portion 127a.

The columnar portion 127a has a circular cross-sectional shape perpendicular to the plate thickness direction. A diameter of the columnar portion 127a is smaller than diameters of the first through hole 147 and the second through hole 137. The columnar portion 127a is inserted into the first through hole 147 and the second through hole 137.

The thermally caulked portion 127b is a portion obtained by melting and re-solidifying the distal end of the columnar portion 127a using heat with a jig for thermal caulking. The thermally caulked portion 127b has a substantially hemispherical shape which is convex downward. The thermally caulked portion 127b is positioned on a side below a lower surface 130b of the third substrate 130. The thermally caulked portion 127b is formed to extend radially outwards from the first through hole 147 and the second through hole 137 when viewed from the vertical direction. A surface facing an upper side of the thermally caulked portion 127b is in contact with the lower surface 130b of the third substrate 130.

According to the present modified example, the thermally caulked portion 127b restricts downward movement of the third substrate 130. Therefore, the third substrate 130 is fixed to the second substrate 120 in a state in which the treatment substrate 4 is sandwiched by the second substrate 120 and the third substrate 130. Further, the treatment substrate 4 sandwiched between the second substrate 120 and the third substrate 130 is fixed to the base material 102.

In the present modified example, the case in which the second substrate 120 has the thermally caulked portion 127b has been described. However, the third substrate 130 may have a thermally caulked portion. That is, through holes overlapping each other are provided in one of the pair of substrates (the second substrate and the third substrate) and the treatment substrate, a convex portion inserted into the two through holes is provided on the other substrate of the pair of substrates (the second substrate and the third substrate), and then a thermally caulked portion may be formed at a distal end of the convex portion.

Although the embodiment of the present invention and its modified example have been described above, the respective configurations, combinations thereof, and the like in the embodiment and its modified example are merely examples, and additions, omissions, substitutions, and other changes to the configurations are possible without departing from the spirit of the present invention. Further, the present invention is not limited by the embodiments.

### DESCRIPTION OF REFERENCE SYMBOLS

1 Fluid device
2, 102 Base material
4 Treatment substrate
4a Upper surface (second facing surface)
5 Sealing portion
10 First substrate
20, 120 Second substrate
20b Lower surface (first facing surface)
21 First accommodating recess (accommodating recess)
26b Stepped surface
29 Insertion hole (through hole)
30, 130 Third substrate
30a Upper surface (third facing surface)
31 Second accommodating recess (accommodating recess)
41 Treatment unit
47 Through hole
50 Flow path
55 Treatment space

1. A fluid device comprising:
a base material including a flow path through which a solution flows and a first facing surface;
a treatment substrate including a second facing surface which faces the first facing surface and in which a treatment unit which comes in contact with the solution and treats the solution is provided; and
a sealing portion sandwiched between the first facing surface and the second facing surface, wherein
a treatment space surrounding the treatment unit with the sealing portion when viewed from a plate thickness direction and connected to the flow path is provided between the treatment substrate and the base material.

2. The fluid device according to claim 1, wherein:
the base material includes a first substrate and a second substrate which are stacked in a plate thickness direction;
the flow path is provided between the first substrate and the second substrate;
the second substrate includes the first facing surface;
a recess constituting the treatment space therein is provided on the first facing surface; and
a bottom surface of the recess is arranged facing the treatment unit.

3. The fluid device according to claim 2, wherein:
a stepped surface is provided on an inner peripheral surface of the recess to face the second facing surface; and
the sealing portion is sandwiched between the stepped surface and the second facing surface.

4. The fluid device according to claim 2, wherein a pair of through holes that penetrate in a plate thickness direction and connect the flow path to the treatment space are provided in the second substrate.

5. The fluid device according to claim 1, wherein:
a base material includes a third substrate;
the third substrate includes a third facing surface facing the first facing surface; and
the treatment substrate is sandwiched between the first facing surface and the third facing surface.

6. The fluid device according to claim 5, wherein an accommodating recess is provided on the first facing surface to accommodate at least a portion of the treatment substrate.

7. The fluid device according to claim 5, wherein an accommodating recess is provided on the third facing surface to accommodate at least a portion of the treatment substrate.

8. The fluid device according to claim 5, wherein a reservoir is provided between the first facing surface and the third facing surface to accommodate the solution and to supply the solution to the flow path.

9. The fluid device according to claim 8, wherein:
the flow path includes a loop-shaped circulation flow path; and
a plurality of quantitative valves are provided in the circulation flow path.

10. The fluid device according to claim 9, wherein:
a plurality of sections are defined in the circulation flow path by the quantitative valves; and
an introduction flow path connected to the reservoir is connected to one end of each of the sections.
